(19) United States
(12) Patent Application Publication
(10) Pub. No.: US 2025/0246982 A1
(43) Pub. Date: Jul. 31, 2025

(54) MOTOR AND MOBILITY DEVICE INCLUDING THE SAME

(71) Applicants: HYUNDAI MOTOR COMPANY, Seoul (KR); KIA CORPORATION, Seoul (KR)

(72) Inventors: Hyung Kwan JANG, Uijeongbu-si (KR); Hoo Dam LEE, Seoul (KR); Kyung Sik CHOI, Seoul (KR); Jun Hyeok CHOI, Suwon-si (KR); Byung Ho MIN, Suwon-si (KR); Tae Gyu LEE, Seoul (KR)

(73) Assignees: HYUNDAI MOTOR COMPANY, Seoul (KR); KIA CORPORATION, Seoul (KR)

(21) Appl. No.: 18/899,140

(22) Filed: Sep. 27, 2024

(30) Foreign Application Priority Data
Jan. 29, 2024 (KR) 10-2024-0013052

(51) Int. Cl. H02K 21/04; B60L 50/60

(52) U.S. Cl. CPC H02K 21/042; B60L 50/60

(57) ABSTRACT

A motor includes a stator including a plurality of stator coils repeatedly mounted in a circumferential direction of the stator; a rotor mounted inside the stator to be rotatable about a rotation shaft and including a plurality of rotor coils interacting with the stator coils; and an auxiliary magnet mounted between the rotation shaft and the rotor coils in a radial direction of the rotation shaft.

### CROSS-REFERENCE TO RELATED APPLICATIONS

The present application claims priority to Korean Patent Application No. 10-2024-0013052 filed on Jan. 29, 2024, the entire contents of which is incorporated herein for all purposes by this reference.

### BACKGROUND OF THE PRESENT DISCLOSURE

### Field of the Present Disclosure

The present disclosure relates to a motor and a mobility device including the same.

### Description of Related art

In general, an electric motor may be classified as a direct current (DC) motor and an alternating current (AC) motor, depending on a power source used therefor. The AC motor may be classified as a synchronous motor and an induction motor depending on structures thereof. The synchronous motor has high efficiency and is easy to control, but is difficult to manufacture and relatively high in price. The induction motor has been widely used because it has a simple structure, is resistant to external shocks, and is inexpensive.

Recently, as research and development of an electric vehicle have accelerated, demand for an electric motor has also increased significantly. The electric motor used as a driving source for an electric vehicle is usually a high-speed and high-power motor.

A mobility device, including a hybrid electric vehicle, an aerial mobility device, or the like, may be partially or entirely driven by a motor, rather than existing internal combustion engines. As a motor for such mobility devices, an interior permanent magnet synchronous motor (IPMSM) with permanent magnets has been widely used. The IPMSM has high efficiency and power.

Recently, a wound field synchronous motor (WFSM) has also come to prominence due to the advantages of reducing the cost of rare earth materials used as permanent magnets and controlling a magnetic field of rotors with current.

However, the conventional wound field synchronous motor has a problem in that the power supplied using a slip ring and brush may be unstable or errors may occur.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a structure of a motor which allows the motor to continue to be operated, even when a power supply problem occurs, by adding a simple structure, while being a field-wound type motor in which a coil is mounted on a rotor.

The purpose of the present disclosure is not limited to the purpose mentioned above, and other objects not mentioned will be clearly understood by those skilled in the art from the description below.

According to an aspect of the present disclosure, a motor may include a stator including a plurality of stator coils repeatedly mounted in a circumferential direction of the stator; a rotor mounted inside the stator to be rotatable about a rotation shaft and including a plurality of rotor coils interacting with the stator coils; and an auxiliary magnet mounted between the rotation shaft and the rotor coils in a radial direction of the rotation shaft.

The auxiliary magnet may be a permanent magnet.

An amount of magnetic flux generated by the auxiliary magnet may be less than an amount of magnetic flux generated by the rotor coil.

The rotor coil may formed by winding a superconducting wire, copper, or aluminum.

The rotor may include: a back yoke into which the rotation shaft is inserted; a plurality of teeth extending from the back yoke in the radial direction; and a corresponding rotor coil wound around the teeth.

The rotor may include a shoe extending from an end portion of the teeth in a circumferential direction of the rotation shaft.

The auxiliary magnet may be mounted in a second slot formed in the back yoke.

The auxiliary magnet may be disposed to be parallel to the teeth in a radial direction thereof.

The auxiliary magnet may be disposed to be staggered with the teeth in a circumferential direction of the rotation shaft.

The auxiliary magnet may be repeatedly mounted at intervals in the circumferential direction thereof.

The auxiliary magnet may be continuously mounted in the circumferential direction thereof.

The auxiliary magnet may be mounted in a first slot formed in the teeth.

The auxiliary magnet may be mounted in a space formed between the back yoke and the rotor coil.

An anti-scattering protrusion protruding from the teeth toward an end portion of the auxiliary magnet may be provided.

The anti-scattering protrusion may include a bridge shape, interconnected to continuously surround the end portion of the auxiliary magnet in the circumferential direction thereof.

According to an aspect of the present disclosure, a motor may include a stator including a plurality of stator coils repeatedly mounted in a circumferential direction of the stator; a rotor mounted inside the stator to be rotatable about a rotation shaft, and including a plurality of rotor coils interacting with the stator coils; and an auxiliary magnet mounted between the rotation shaft and the rotor coils in a radial direction, wherein the rotor coil may include an inset type inserted into the rotor, and the auxiliary magnet may be inserted between the rotation shaft and the rotor coil in an inset type.

The auxiliary magnet may be repeatedly mounted continuously in a circumferential direction of the rotation shaft.

The auxiliary magnet may be repeatedly mounted with N-poles and S-poles in the circumferential direction thereof.

The auxiliary magnets may be spaced apart in the circumferential direction and may be repeatedly mounted with N-poles and S-poles.

According to an aspect of the present disclosure, a mobility device may include a body; at least one driving means mounted in the body; a battery mounted in the body; and the motor, connected to the battery and providing driving force to the at least one driving means.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a combined perspective view of a motor according to an exemplary embodiment of the present disclosure.

FIG. 2 is an exploded perspective view of a motor according to an exemplary embodiment of the present disclosure.

FIG. 3, FIG. 4, FIG. 5, FIG. 6, FIG. 7A, FIG. 7B, FIG. 8A and FIG. 8B are cross-sectional views of a motor according to an exemplary embodiment of the present disclosure.

FIG. 9A, FIG. 9B, FIG. 9C, and FIG. 9D are reference diagrams illustrating performance of a motor according to an exemplary embodiment of the present disclosure.

FIG. 10, and FIG. 11 are cross-sectional views of a motor according to another exemplary embodiment of the present disclosure.

FIG. 12, FIG. 13A and FIG. 13B are perspective views exemplarily illustrating an example of a mobility device to which a motor is applied according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

While the present disclosure may be modified in various ways and take on various alternative forms, specific embodiments thereof are illustrated in the drawings and described in detail below. However, it should be understood that there is no intent to limit the present disclosure to the forms disclosed, but on the other hand, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of at least one of the associated listed items.

The terms, such as “unit, part, portion, etc.” may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure is not intended to limit the scope of the present disclosure. The articles “a,” and “an” are singular in that they have a single referent, however the use of the singular form in the present specification should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and they should not be construed to have ideally or excessively formal meanings, unless clearly defined in the application.

In the present specification, a mobility device may move in a space related to the ground, underground, air, space, sea, and/or underwater, depending on the space in which the mobility device moves. Mobility devices on the ground or underground may be provided in a form of, for example, vehicles, robots, etc., and mobility devices in the air or space, as aerial mobility devices, may be provided in a form of, for example, typical fixed-wing or rotary-wing aircraft, advanced aerial mobility devices (AAMs), which have been actively developed recently, unmanned aerial vehicles or drones, rockets, and units of transportation mounted on artificial satellites. A maritime or underwater mobility device 10 may be, for example, a ship, a submarine, or the like. The mobility device 10 is not limited to a specific space and may be a mobile body which may move through all of the aforementioned spaces, that is, a mobile body which may move between a plurality of spaces, and may be, for example, an amphibious vehicle, a flying vehicle, etc.

In the description below, the terms “anterior,” “posterior,” “lateral,” “front,” “rear,” “up/down,” “above,” “upper,” “top,” “below,” “lower,” “bottom,” “left/right,” etc. are defined based on a vehicle or a vehicle body. Furthermore, terms, such as first and second may be used to describe various components, but these components should not be limited in order, size, location, or importance by terms, such as first and second. These terms are only used to distinguish one component from another.

Hereinafter, various exemplary embodiments of the present disclosure will be described in more detail with reference to the appended drawings.

As is well known, a motor includes a stator and a rotor, and the rotor is configured to rotate by electromagnetic interaction between the stator and the rotor. As previously introduced, motors include a permanent magnet synchronous motor (PMSM) in which a permanent magnet is used in a rotor and a wound field synchronous motor (WFSM) in which a field coil is wound around a rotor.

That is, in the WFSM, coils are used instead of permanent magnets to generate magnetic flux in the rotor. Specifically, field magnetic flux is generated by winding a coil around the teeth of the rotor. Typically, in the case of WFSM, a coil is wound around an electrical steel sheet, and field magnetic flux may be allowed to pass through an air gap via the electrical steel sheet. However, when manufacturing a field coil using a superconducting wire, both core-type motors including an electrical steel sheet and coreless-type motors not including an electrical steel sheet may be used. The coreless-type motors may include non-magnetic materials, instead of an electrical steel sheet, and may include plastic, stainless steel, copper, aluminum, etc., as non-limiting examples of materials.

Many of these problems may occur in the case of superconducting motors using a superconducting wire as the rotor coil. The superconducting motors are often manufactured in a structure in which a race track-shaped coil is provided on the rotor. The rotor coil may be formed of a superconducting wire or a material, such as highly conductive copper or aluminum, and the rotor coil may be provided in a race track shape and inserted into the rotor. However, the present disclosure is not limited thereto, and the rotor coil may be formed of various materials and may be provided in the rotor in various structures.

On the other hand, the wound field synchronous motor (WFSM) supplies power using a slip ring and a brush, and because power is supplied through a structure which rotates while maintaining contact between the slip ring and the brush rather than a directly connected structure, the wound field synchronous motor (WFSM) may have unstable power supply or errors may occur.

Accordingly, in an exemplary embodiment of the present disclosure, based on the fact that the power supply to the rotor coil may become unstable, when the power supply is cut off and the rotor coil cannot serve as a practical driving unit, an auxiliary magnet that can serve as a driving unit of the rotor may be provided instead thereof. Furthermore, the position of the auxiliary magnet may be designed to be optimal so that actual driving of the motor may be performed.

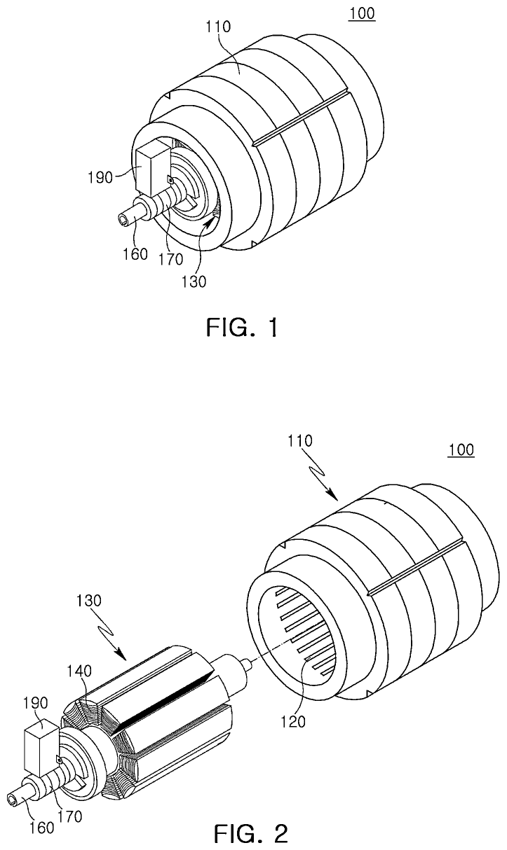

Referring to FIG. 1 and FIG. 2, the motor 100 according to an exemplary embodiment of the present disclosure may include a stator 110 and a rotor 130. The rotor 130 may be fixed on a rotation shaft 160, and the rotor 130 can rotate around the rotation shaft 160 together with the rotation shaft 160 inside the stator 110.

Hereinafter, a direction in which the rotation shaft extends is defined as a rotation shaft direction, a direction perpendicular to the rotation shaft is defined as a radial direction, and a direction in which the rotor rotates around the rotation shaft is defined as a circumferential direction thereof.

The motor 100 of the exemplary embodiment may have coils in both the stator 110 and the rotor 130. That is, the stator coil 120 and the rotor coil 130 may be used as a driving source for driving the rotor 130.

That is, the motor 100 of the exemplary embodiment of the present disclosure is a field-wound motor including a coil in the rotor, and accordingly, a means for supplying power to the rotor coil 130 provided in the rotating rotor 130 is required. Accordingly, the motor 100 of the exemplary embodiment may be provided with a slip ring 170 and a brush 190.

The slip ring 170 is an annular conductor provided on the rotation shaft 160, and the slip ring 170 may be electrically connected to the rotor coil 130. Furthermore, the brush 190 may be fixedly provided on the stator 110 to maintain electrical contact even when the slip ring 170 rotates. Accordingly, when power is supplied through the brushes 190, power may be supplied to the rotor coil 130 through the slip ring 170.

Ultimately, the stator 110, stator coil 120, and brushes 190 correspond to members that are fixed and do not rotate, and the rotor 130, rotor coil 140, rotation shaft 160, and slip ring 170 correspond to rotation members that rotate relative to the stator 110.

An air gap G may be provided between the stator 110 and the rotor 130 to facilitate rotation of the rotor 130. Accordingly, a magnetic air gap length GL may be formed between the stator 110 and the rotor 130.

As shown in FIG. 1 and FIG. 2, because power is supplied to the rotor coil 140 of the rotor 130 through the slip ring 170 and brush 190, power may not be smoothly supplied, and in the instant case, the driving of the motor may be stopped. Accordingly, in an exemplary embodiment of the present disclosure, even when power is not supplied to the rotor coil 140, an auxiliary magnet 150 that can continue the rotation of the rotor 130 may be provided by interacting with the stator coil 120.

Ultimately, the motor 100 of the exemplary embodiment may include a stator 110 including a plurality of stator coils 120 repeatedly disposed in the circumferential direction, a rotor 130 provided inside the stator 110 to be rotatable about the rotation shaft 160, and including a plurality of rotor coils 140 interacting with the stator coil 120, and an auxiliary magnet 150 provided between the rotation shaft 160 and the rotor coil 140 in the radial direction thereof.

The auxiliary magnet 150 may be provided as a permanent magnet. Furthermore, when power is smoothly supplied to the rotor coil 140, it is advantageous for control if the auxiliary magnet 150 does not affect the driving of the motor as much as possible, and thus an amount of magnetic flux generated by the auxiliary magnet 150 may be less than an amount of magnetic flux generated by the rotor coil 140.

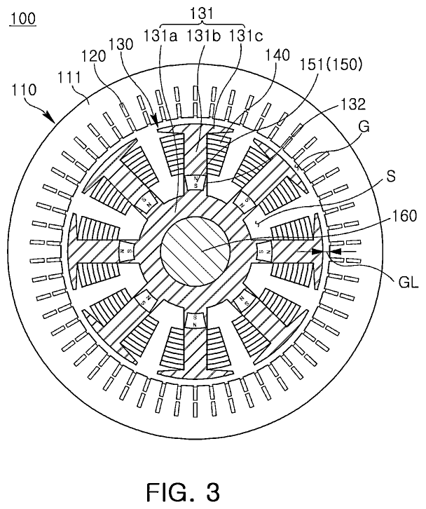

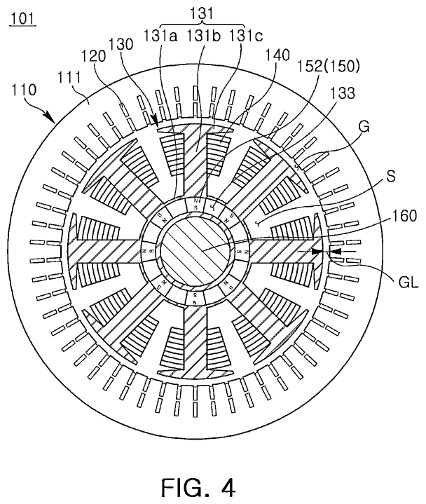

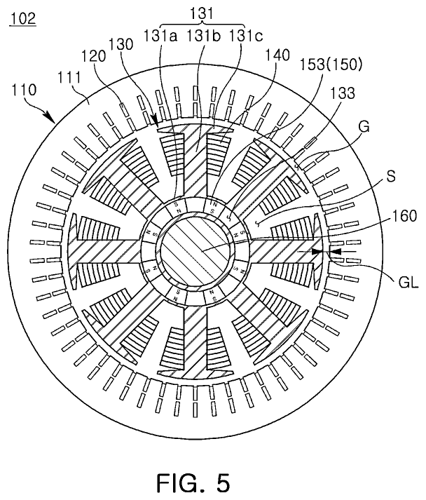

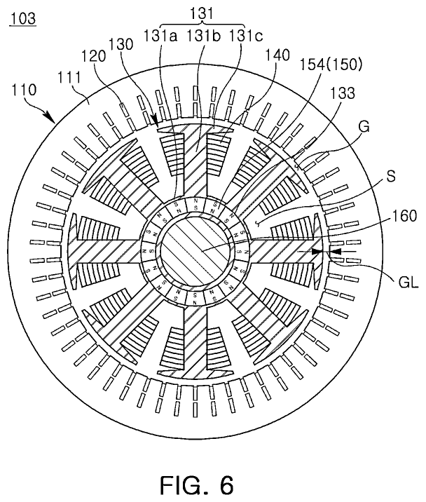

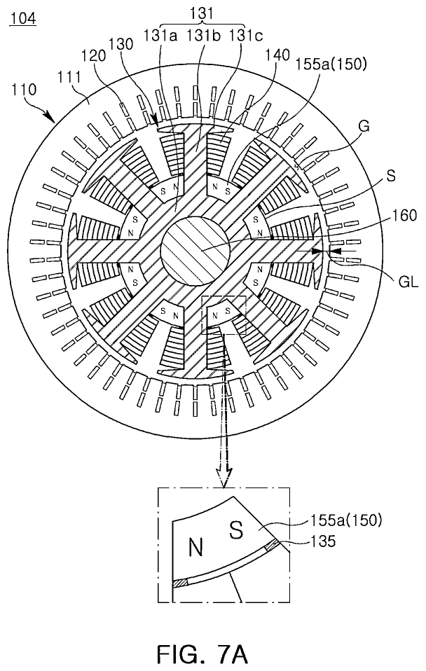

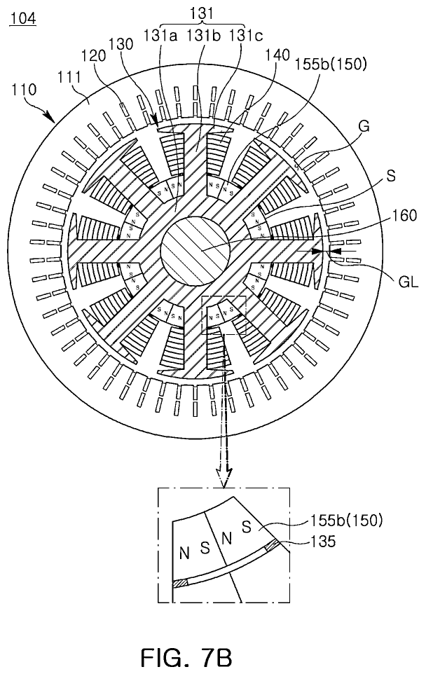

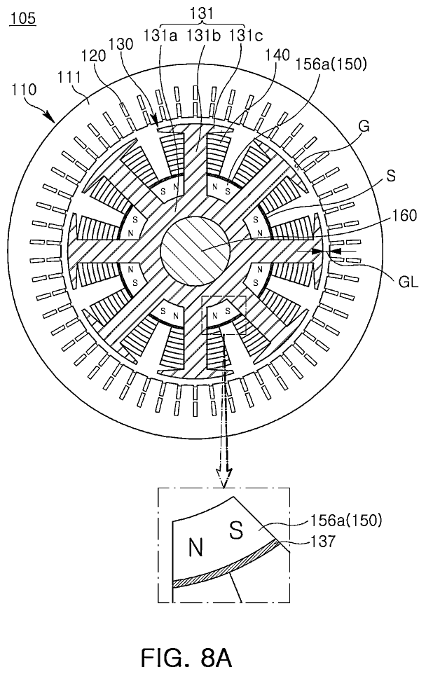

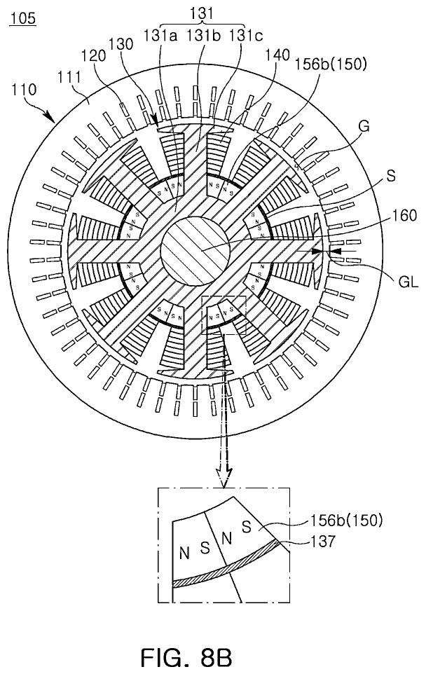

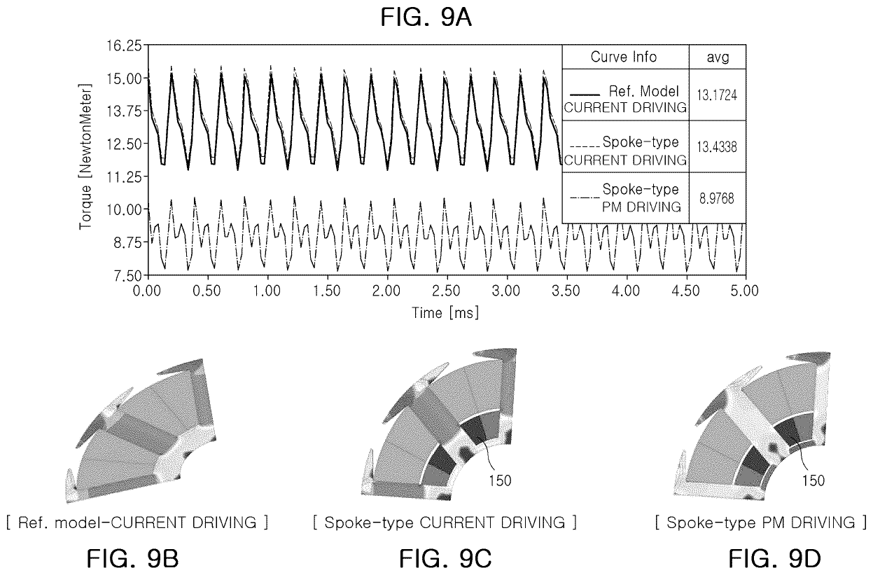

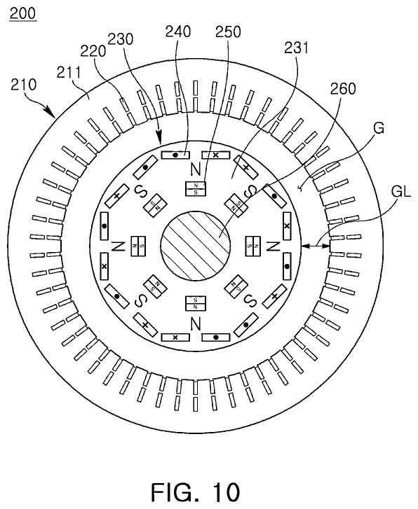

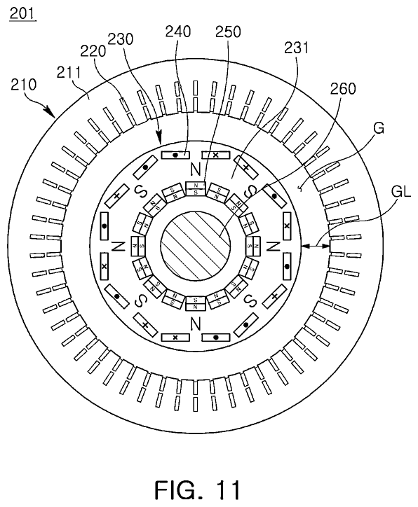

The exemplary embodiment may also be applied to a structure in which the rotor coil 140 is wound around or inserted into the teeth (FIG. 3, or FIG. 9), and may also be applied to the inset type in which the rotor coil 140 is provided in the slot of the rotor 130 (FIG. 10, and FIG. 11).

The stator 110 may include a stator body 111 and a stator coil 120. The stator coil 120 may be wound or inserted into the core 111 provided in the stator body 111. The stator coil 120 may be provided in plural and the plurality of stator coils 120 may be repeatedly disposed in a circumferential direction thereof. Here, the circumferential direction may refer to a direction in which the rotor rotates. Although not shown, the stator coil 130 may be formed of a separately provided steel plate or coreless body and provided on the stator body 110.

The rotor 130 may be fixed on the rotation shaft 160, which is the rotation center.

The rotor 130 may be provided inside the stator 110 to be rotatable about the rotation shaft 160, and may include a plurality of rotor coils 140 interacting with the stator coil 120 to generate rotation force.

The rotor coil 140 may be provided in the rotor body 131 fixed provided on the rotation shaft 160. The rotor coil 140 may be wound around the teeth (or the core 131b) provided in the rotor body 131 or may be manufactured separately and inserted thereinto. The rotor coil 140 may be provided in plural and the plurality of rotor coils 140 may be repeatedly disposed in the circumferential direction to face the stator coil 120.

The rotor body 131 may include a back yoke 131a into which the rotation shaft 160 is fixedly inserted, a plurality of teeth 131b extending radially from the back yoke 131a, and a rotor coil 140 wound around the teeth 131b. The back yoke 131a may be provided in an annular shape so that the rotation shaft 160 may be fixed in the middle thereof. The teeth 131b is configured as a core around which the rotor coil 140 is wound.

Furthermore, an end portion of the teeth 131b may include a shoe 131c extending in the circumferential direction from the teeth 131b. By providing the shoe 131c, the magnetic force required to drive the motor may be concentrated.

The rotor coil 140 may be a superconducting wire. However, the present disclosure is not limited, and the rotor coil 140 may be formed of a conductive material such as copper or aluminum. The rotor coil 140 may be wound around the teeth 131b (core). Alternatively, the rotor coil 140 may be provided in a race track shape, may include a core, or may be provided in a coreless shape without a core (for a structure without a core, see the inset type shown in FIG. 10, and FIG. 11).

The motor 100 of the exemplary embodiment may be provided with an auxiliary magnet 150 that interacts with the stator coil 120 to drive the motor in case power supply to the rotor coil 140 is not smoothly performed. That is, the motor 100 of the exemplary embodiment may include an auxiliary magnet 150 provided between the rotation shaft 160 and the rotor coil 140 in the radial direction thereof.

The auxiliary magnet 150 may be provided as a permanent magnet. Furthermore, when power is smoothly supplied to the rotor coil 140, it is advantageous for control if the auxiliary magnet 150 does not affect the driving of the motor as much as possible, and thus an amount of magnetic flux generated by the auxiliary magnet 150 may be less than an amount of magnetic flux generated by the rotor coil 140.

The auxiliary magnet 150 may be provided between the rotation shaft 160 and the rotor coil 140 in the radial direction thereof.

Referring to FIG. 3, in the motor 100 of an exemplary embodiment of the present disclosure, auxiliary magnets 150 and 151 may be provided in the teeth 131b. In detail, the auxiliary magnets 150 and 151 may be provided in a first slot 132 provided in the teeth 131b.

Furthermore, referring to FIG. 4, FIG. 5 and FIG. 6, in an exemplary embodiment of the motors 101, 102, and 103, the auxiliary magnet 150 may be provided on the back yoke 131a. In detail, the auxiliary magnet 150 may be provided in a second slot 133 provided in the back yoke 131a.

In the instant case, the auxiliary magnet 150 may be provided on the back yoke 131a, the auxiliary magnet 150 may be repeatedly provided at intervals in the circumferential direction, and the auxiliary magnet 150 may be disposed to be parallel to the teeth 131b in the radial direction (FIG. 4), or the auxiliary magnet 150 may be disposed to be staggered with the teeth 131b in the circumferential direction (FIG. 5).

Furthermore, when the auxiliary magnet 150 is provided on the back yoke 131a, the auxiliary magnet 150 may be provided continuously in the circumferential direction (FIG. 6).

Meanwhile, as shown in FIG. 7A and FIG. 7B, in a motor 104 of an exemplary embodiment of the present disclosure, the auxiliary magnets (150 to 155a and 155b) may be provided in a space (a rotor slot, S) provided between the back yoke 131a and the rotor coil 140. In other words, the auxiliary magnet 150 may be provided in the space S formed between the teeth 131b, and as shown in FIG. 7A, a NS magnet 155a including an N-pole and an S-pole may be disposed in each space, and as shown in FIG. 7B, NS-NS magnets 155b in which magnets including N and S-poles are continuously provided in the circumferential direction may be disposed in each space (In FIG. 7B, two NS magnets are shown in a continuous shape, but this is merely an example and three or more magnets may be continuously provided).

In the instant case, to prevent the auxiliary magnet 150 from scattering, an anti-scattering protrusion 135 protruding from the teeth 131b in the circumferential direction may be provided at an end portion of the auxiliary magnet 150 in the radial direction thereof. The anti-scattering protrusion 135 may be provided on both sides of the auxiliary magnet 150 in the circumferential direction thereof.

Furthermore, as shown in FIGS. 8A and 8B, in the motor 105 of an exemplary embodiment of the present disclosure, the auxiliary magnets 150 to 156a and 156b may also be provided in a space (a rotor slot, S) provided between the back yoke 131a and the rotor coil 140. In other words, the auxiliary magnet 150 may be provided in the space S formed between the teeth 131b, and as shown in FIG. 8A, a NS magnet 156a including an N-pole and an S-pole may be disposed in each space, and as shown in FIG. 8B, NS-NS magnets 156b in which magnets including N and S-poles are continuously provided in the circumferential direction may be disposed in each space (In FIG. 8B, two NS magnets are shown in a continuous shape, but this is merely an example and three or more magnets may be continuously provided).

In the instant case, to prevent the auxiliary magnet 150 from scattering, an anti-scattering protrusion protruding from the teeth 131b in the circumferential direction may be provided at an end portion of the auxiliary magnet 150 in the radial direction, and the anti-scattering protrusion may be a bridge 137 for preventing auxiliary magnets from scattering. That is, the scattering prevention protrusion may include a shape of bridges 137 that are interconnected to continuously surround the end portion of the auxiliary magnet 150 in the circumferential direction thereof.

In the motor 105 of an exemplary embodiment of the present disclosure, when the auxiliary magnet 150 is provided in the space (rotor slot, S) provided between the back yoke 131a and the rotor coil 140, the auxiliary magnet 150 may be located anywhere inside the rotor slot, and an appropriate region of the slot region may be used to install the auxiliary magnet 150. For example, up to 10 to 50% of the rotor slot may be used as a permanent magnet region, but the present disclosure is not limited thereto.

Meanwhile, FIG. 9A, FIG. 9B and FIG. 9C is a reference diagram illustrating a graph (FIG. 9A) comparing torque waveforms for each operation mode of a field winding type spoke-type rotor, and comparative examples and examples (FIGS. 9B, 9C and 9D) applied thereto.

Referring to FIG. 9A, FIG. 9B, FIG. 9C, and FIG. 9D, the field-wound motor 100 generates field flux by applying current to a field coil (i.e., rotor coil, 140) and rotates by the rotating magnetic field of the stator 110. When current is applied to a Ref. model in FIG. 9B and a spoke-type rotor in FIG. 9C, and the motor is driven, it may be seen that the torque is at the same level. That is, there is no output contribution by the auxiliary magnet 150, and there is little change in output characteristics such as torque ripple or the like.

When the slip ring and brush of the rotor 130 are broken, the torque when driving the motor by the auxiliary magnet (PM) 150 shows an output of about 68%, as compared to current driving, so that it may be seen that emergency operation may be performed. Furthermore, a driving output of the motor by the auxiliary magnet 150 may be increased or decreased by designing the usage of the auxiliary magnet.

Next, referring to FIG. 10, and FIG. 11, the motors 200 and 201 of the exemplary embodiment may also be applied to the inset type in which the rotor coil is inserted into the rotor, that is, the rotor body 231.

As shown in FIG. 10, the plurality of rotor coils 240 are repeatedly disposed in the circumferential direction, and may be formed in pairs to implement an N-pole or an S-pole. Accordingly, the pair of rotor coils 240 may ultimately allow the N-pole and the S-pole to be implemented alternately in the circumferential direction, and the rotor coils 240 may interact with the stator coil 220 to generate torque. The rotor coil 240 may include an inset type inserted into a slot of the rotor body 231.

A motor 200 according to another exemplary embodiment of the present disclosure may include a stator 210 and a rotor 230, as shown in FIG. 10. The rotor 230 may be fixed on a rotation shaft 260 and the rotor 230 can rotate around the rotation shaft 260 together with the rotation shaft 260 inside the stator 210.

That is, the motor 200 according to another exemplary embodiment of the present disclosure may include a stator 210 including a plurality of stator coils 220 repeatedly disposed in the circumferential direction, a rotor 230 provided inside the stator 210 to be rotatable about the rotation shaft 260, and including a plurality of rotor coils 240 interacting with the stator coil 220, and an auxiliary magnet 250 provided between the rotation shaft 260 and the rotor coil 240 in the radial direction thereof. Furthermore, the rotor coil 240 may include an inset type inserted into the rotor 230, and the auxiliary magnet 250 may be inserted between the rotation shaft 260 and the rotor coil 240 in an inset type.

An air gap G is provided between the stator S and the rotor R, to facilitate rotation of the rotor 230. Accordingly, a magnetic air gap length GL is formed between the stator 210 and the rotor 230.

The stator 210 may include a stator body 211 and a stator coil 220. The stator coil 220 may be wound around a core provided on the stator body 211. The stator coil 220 may be provided in plural and the plurality of stator coils 130 may be repeatedly disposed in a circumferential direction thereof. Here, the circumferential direction may refer to a direction in which the rotor rotates. The stator coil 220 may be formed of a separately provided steel plate or coreless body and provided on the stator body 211.

The rotor 230 may be fixed on the rotation shaft 260, which is the rotation center.

The rotor 230 may be rotatably provided inside the stator 210 about the rotation shaft 260, and may include a plurality of rotor coils 240 interacting with the stator coil 220 to generate rotation force.

The rotor coil 240 may be provided on the rotor body 231 fixed on the rotation shaft 260. The rotor coil 240 may be wound around a core provided in the rotor body 231 or may be manufactured separately and provided on the rotor body 231. The rotor coil 240 may be provided in plural and the plurality of rotor coils 240 may be repeatedly disposed in the circumferential direction to face the stator coil 220.

The rotor coil 240 may be a superconducting wire. However, the present disclosure is not limited, and the rotor coil 240 may be formed of a conductive material, such as copper or aluminum. The rotor coil 240 may be provided in a race track shape, may include a core, or may be provided in a coreless form, without a core.

Meanwhile, referring to FIG. 10, an auxiliary magnet 250 provided in the motor 200 of another exemplary embodiment of the present disclosure may be provided repeatedly in a circumferential direction, and the auxiliary magnet 250 may be spaced from each other in the circumferential direction thereof.

Furthermore, referring to FIG. 11, the auxiliary magnet 250 provided in the motor 201 of another exemplary embodiment of the present disclosure may be provided repeatedly in the circumferential direction, and may be disposed continuously in the circumferential direction thereof.

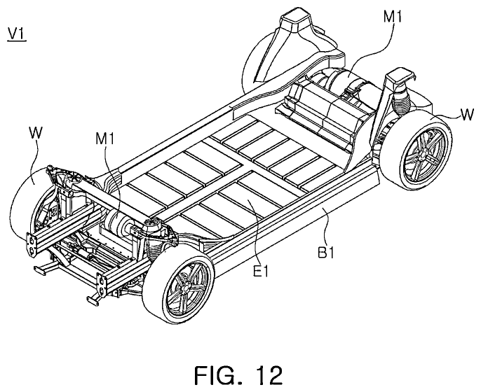

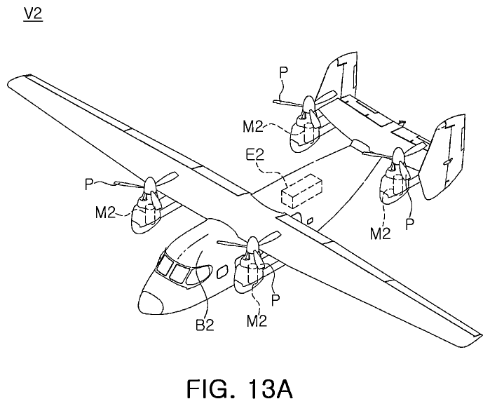

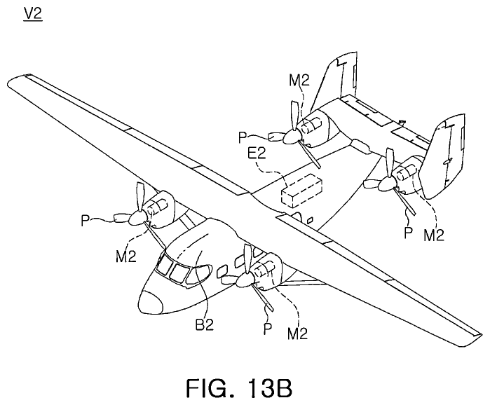

FIGS. 12, 13A, and 13B are perspective views exemplarily illustrating an example of a mobility device to which a motor according to an exemplary embodiment of the present disclosure is applied.

The mobility devices V1 and V2 according to an exemplary embodiment of the present disclosure may include at least a body B1 and B2, driving means including wheels W and propellers P mounted in the bodies B1 and B2, motors M1 and M2, and 100, 101, 102, 103, 104, 105,200, and 201, interworking with the driving means W and P, and batteries E1 and E2 providing power to the motors. The motors M1 and M2 provided in the mobility devices V1 and V2 of the exemplary embodiment may be one or more of the motors 100, 101, 102, 103, 104, 105, 200, and 201 described with reference to FIGS. 1 to 11. Because the motors 100, 101, 102, 103, 104, 105, 200, and 201 described above with reference to FIG. 1, FIG. 2, FIG. 3, FIG. 4, FIG. 5, FIG. 6, FIG. 7, FIG. 8 and FIG. 9 may be provided, and thus, a detailed description of the motors M1 and M2 will be omitted.

Referring to FIG. 12, the mobility device VI in various exemplary embodiments of the present disclosure may be a vehicle which may move on the ground. The vehicle V1, which is a mobility device, may include at least the body B1, a wheel W as a driving means provided in the body B1, the motor M1 linked to the driving means W, and the battery E1 providing power to the motor.

Furthermore, referring to FIGS. 13A and 13B, the mobility device V2 in various exemplary embodiments of the present disclosure may be an aerial mobility device that moves in the air. The aerial mobility device V2 of various exemplary embodiments of the present disclosure may include at least a fuselage B2 as a body, a propulsion body (a propeller P) as a driving unit provided in the fuselage B2, the motor M2 linked to the propeller P, and the battery E2 providing power to the motor.

FIG. 13A illustrates a position of the propeller P when the aerial mobility device V2 takes off or lands or hovers for turning at a specific point, and FIG. 13B illustrates a position of the propeller P when the aerial mobility device V2 moves in position, that is, drives. In other words, the aerial mobility device V2 may include a structure in which a direction of the propeller P, which is a propulsion body of the aerial mobility device V2, is tilted, and accordingly, the motor 1000 driving the propeller P may also be tilted.

In the case of a hovering mode illustrated in FIG. 13A, a main wing and/or tail wing tilting propeller P may be pivoted to be substantially perpendicular to the fuselage B2, and in the case of a cruise mode illustrated in FIG. 13B, the main wing and/or tail wing non-tilting propeller P may be pivoted to be substantially parallel to the fuselage B2. The tilting of the main wing and/or tail wing tilting propeller P may be synchronized depending on a flight mode, and tilting of each propeller may be adjusted to be different depending on posture control and flight conditions in the same flight mode.

Meanwhile, although specific illustrations are omitted, a mobility device may be a device that moves through spaces related to the ground, underground, air, space, sea, and/or underwater, depending on the space in which the mobility device moves. Mobility devices on the ground or underground may be provided in a form of, for example, vehicles, robots, etc., and mobility devices in the air or space, as aerial mobility devices, may be provided in a form of, for example, typical fixed-wing or rotary-wing aircraft, advanced aerial mobility devices (AAMs), which have been actively developed recently, unmanned aerial vehicles or drones, rockets, and units of transportation mounted on artificial satellites. A maritime or underwater mobility device may be, for example, a ship, a submarine, or the like. The mobility device is not limited to a specific space and may be a mobile body which may move through all of the aforementioned spaces, that is, a mobile body which may move between a plurality of spaces, and may be, for example, an amphibious vehicle, a flying vehicle, and the like.

As set forth above, the motor according to an exemplary embodiment of the present disclosure may allow the motor to continue driving even when a power supply is unstable by adding a simple structure to a field-wound motor with a coil on the rotor.

The motor according to an exemplary embodiment of the present disclosure may be implemented by simple structural changes, so that reliability may be improved without significant modification compared to the related art, achieving an effect of substantially reducing costs.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A motor, comprising:
a stator including a plurality of stator coils repeatedly mounted in a circumferential direction of the stator;
a rotor mounted inside the stator to be rotatable about a rotation shaft and including a plurality of rotor coils interacting with the stator coils; and
an auxiliary magnet mounted between the rotation shaft and the rotor coils in a radial direction of the rotation shaft.

2. The motor of claim 1, wherein the auxiliary magnet is a permanent magnet.

3. The motor of claim 2, wherein an amount of magnetic flux generated by the auxiliary magnet is less than an amount of magnetic flux generated by the rotor coils.

4. The motor of claim 1, wherein the rotor coils are formed by winding a superconducting wire, copper, or aluminum.

5. The motor of claim 1, wherein the rotor includes:
a back yoke into which the rotation shaft is inserted;
a plurality of teeth extending from the back yoke in the radial direction; and
a corresponding rotor coil wound around the teeth.

6. The motor of claim 5, wherein the rotor further includes a shoe extending from an end portion of the teeth in the circumferential direction.

7. The motor of claim 5, wherein the auxiliary magnet is mounted in a second slot formed in the back yoke.

8. The motor of claim 7, wherein the auxiliary magnet is disposed to be parallel to the teeth in the radial direction.

9. The motor of claim 7, wherein the auxiliary magnet is disposed to be staggered with the teeth in the circumferential direction.

10. The motor of claim 7, wherein the auxiliary magnet is in plural and the plurality of auxiliary magnets is repeatedly mounted at intervals in the circumferential direction.

11. The motor of claim 7, wherein the auxiliary magnet is in plural and the plurality of auxiliary magnets is continuously mounted in the circumferential direction.

12. The motor of claim 5, wherein the auxiliary magnet is mounted in a first slot formed in the teeth.

13. The motor of claim 5, wherein the auxiliary magnet is mounted in a space between the back yoke and a corresponding rotor coil.

14. The motor of claim 13, wherein an anti-scattering protrusion is formed to protrude from the teeth toward an end portion of the auxiliary magnet.

15. The motor of claim 14, wherein the anti-scattering protrusion includes a bridge, which is interconnected to continuously surround the end portion of the auxiliary magnet in the circumferential direction.

16. A motor, comprising:
a stator including a plurality of stator coils repeatedly mounted in a circumferential direction of the stator;
a rotor mounted inside the stator to be rotatable about a rotation shaft and including a plurality of rotor coils interacting with the stator coils; and
an auxiliary magnet mounted between the rotation shaft and the rotor coils in a radial direction of the rotation shaft,
wherein the rotor coils include an inset type inserted into the rotor, and
wherein the auxiliary magnet is inserted between the rotation shaft and the rotor coils in the inset type.

17. The motor of claim 16, wherein the auxiliary magnet is in plural and the plurality of auxiliary magnets is repeatedly mounted continuously in the circumferential direction.

18. The motor of claim 17, wherein the auxiliary magnet is in plural and the plurality of auxiliary magnets is mounted with N-poles and S-poles repeatedly in the circumferential direction.

19. The motor of claim 16, wherein the auxiliary magnet is in plural, and the plurality of auxiliary magnets is spaced apart in the circumferential direction and is repeatedly mounted with N and S-poles.

20. A mobility device, comprising:
a body;
at least one driving means mounted in the body;
a battery mounted in the body; and
the motor of claim 1, which is connected to the battery and supplies driving force to the at least one driving means.
